(19) United States
(12) Patent Application Publication
(10) Pub. No.: US 2025/0124906 A1
(43) Pub. Date: Apr. 17, 2025

(54) AUDIO REVERBERATION METHOD AND SYSTEM

(71) Applicant: AAC Acoustic Technologies (Shanghai) Co., Ltd., Shanghai (CN)

(72) Inventors: Lianwu Chen, Shanghai (CN); Xuejing Sun, L.A., CA (US)

(21) Appl. No.: 18/399,807

(22) Filed: Dec. 29, 2023

Related U.S. Application Data
(63) Continuation of application No. PCT/CN2023/123943, filed on Oct. 11, 2023.

(51) Int. Cl. G10H 1/36

(52) U.S. Cl. CPC G10H 1/366; G10H 2210/036; G10H 2210/291

(57) ABSTRACT

An audio reverberation method includes: preprocessing an input audio signal to obtain a reverberation input signal; reverbing the reverberation input signal to generate an initial reverberation audio signal of a target scene; performing audio content analysis on the input audio signal to obtain an audio content feature of the input audio signal; determining a content-adaptive masking matrix based on the audio content feature; performing weighted mixing on the content-adaptive masking matrix and the initial reverberation audio signal to obtain a content-adaptive reverberation signal; and performing weighted mixing on the content-adaptive reverberation signal and the reverberation input signal according to a preset ratio to obtain a final reverberation audio signal. According to the embodiments of the present disclosure, audio signals with different audio content are adapted to different reverberation effects, avoiding the problem of distortion of the final reverberation audio signal.

### CROSS-REFERENCE TO RELATED APPLICATIONS

This application is a continuation of International Application No. PCT/CN2023/123943, filed on Oct. 11, 2023, which is hereby incorporated by reference in its entirety.

### TECHNICAL FIELD

The present disclosure relates to the field of audio reverberation technologies, and in particular, to an audio reverberation method and system.

### BACKGROUND

In the design of sound effects, in the related art, it may be common to simulate hearing effects in different acoustic scenes by superimposing a specific reverberation signal on an original audio.

Common reverberation generation methods include a convolution reverberation method and an artificial reverberation method. The convolution reverberation method means measuring a room impulse response (RIR) of an actual scene in the scene, and then performing a convolution operation on a target audio and the RIR during generation of a sound effect, to reproduce a corresponding reverberation effect. With the convolution reverberation method, a realistic confusion effect can be achieved, with high complexity. The artificial reverberation method means simulating generation of reverberation through a model method, including early radiation, late reverberation, time delay, frequency attenuation characteristics, and the like, to simulate a reverberation effect of a target scene. The artificial reverberation method is more flexible and has low complexity.

Different music content may differ in effect after superimposition of reverberation. Some genres of audio, such as music including fast-paced drumming sounds, may easily produce confusion effects after superimposition of a large amount of reverberation. In addition, some audio content has reverberation, and superimposition of reverberation on this basis may also result in more reverberation than expected.

In the related art, a virtual acoustic scene solution for an environment inside a vehicle is proposed. In the solution, a microphone signal and a music signal are inputted and processed by a pre-processing module (including dry-sound signal extraction) to obtain an input signal required for artificial reverberation, then the input signal is processed by using a reverberation generation algorithm, to obtain a multi-channel artificial reverberation signal, and finally, the multi-channel artificial reverberation signal is processed by post-processing modules such as time delay, gain control, and wet and dry sound ratio mixing modules, to obtain final virtual scene audio output.

However, although the above solution in the related art can ensure, through the dry-sound signal extraction, that double reverberation may not be superimposed on a reverberation component of the input signal, an algorithm for directly extracting a dry-sound signal generally has a problem of distortion, and reverberation generation and dry and wet sound mixing on this basis may result in that a reverberation signal finally outputted also has the problem of distortion. Moreover, the above solution does not take into account reverberation effects of different music styles.

### SUMMARY

The present disclosure is intended to solve at least one of the problems in the related art and provides an audio reverberation method and system.

A first aspect of the present disclosure provides an audio reverberation method. The audio reverberation method includes:
preprocessing an input audio signal to obtain a reverberation input signal;
reverbing the reverberation input signal to generate an initial reverberation audio signal of a target scene;
performing audio content analysis on the input audio signal to obtain an audio content feature of the input audio signal;
determining a content-adaptive masking matrix based on the audio content feature;
performing weighted mixing on the content-adaptive masking matrix and the initial reverberation audio signal to obtain a content-adaptive reverberation signal; and
performing weighted mixing on the content-adaptive reverberation signal and the reverberation input signal according to a preset ratio to obtain a final reverberation audio signal.

In an embodiment, the audio content feature includes a music style; and the performing audio content analysis on the input audio signal to obtain an audio content feature of the input audio signal includes:
obtaining the music style of the input audio signal based on an audio tag of the input audio signal; or
obtaining an audio feature based on a music spectrum of the input audio signal, and inputting the audio feature into a pre-trained music classification model to obtain the music style of the input audio signal; wherein the music classification model is trained by using audio features and corresponding classification tags.

In an embodiment, the audio content feature includes drumbeat intensity; and the performing audio content analysis on the input audio signal to obtain an audio content feature of the input audio signal includes:
determining abrupt change points of the input audio signal based on a note onsets detection scheme by using energy or spectrum change information, taking the abrupt change points whose abrupt change degrees are greater than a preset abrupt change threshold as drumbeats, and obtaining the drumbeat intensity of the input audio signal based on a number of the drumbeats in a preset duration; or
inputting a multi-frame spectrum of the input audio signal into a pre-trained drumbeat detection model to obtain probabilities of respective time points corresponding to drumming sounds, taking the time points with the probabilities greater than a preset probability threshold as drumbeats, and obtaining the drumbeat intensity of the input audio signal based on a number of the drumbeats in a preset duration.

In an embodiment, the audio content feature includes a reverberation degree; and the performing audio content analysis on the input audio signal to obtain an audio content feature of the input audio signal includes:
inputting a signal spectrum of the input audio signal into a pre-trained de-reverberation model to obtain a time-frequency masking matrix corresponding to de-reverb; or
performing dry sound and wet sound separation on the signal spectrum of the input audio signal, and taking a ratio of a signal spectrum of dry sounds obtained by separation to the signal spectrum of the input audio signal as a time-frequency masking matrix;
wherein the time-frequency masking matrix is used to represent the reverberation degree of each time-frequency point.

In an embodiment, the pre-trained de-reverberation model is trained according to the following steps:
acquiring a clean audio and a reverberation audio thereof, and training the de-reverberation model by using a reverberation audio spectrum of the reverberation audio as input of the de-reverberation model and the time-frequency masking matrix corresponding to the de-reverberation as output of the de-reverberation model; or
acquiring a clean audio and a reverberation audio thereof, generating a first target artificial reverberation audio based on the clean audio, and generating a second target artificial reverberation audio based on the reverberation audio; and training the de-reverberation model by using the reverberation audio as input of the de-reverberation model and a time-frequency masking matrix corresponding to a ratio of the first target artificial reverberation audio to the second target artificial reverberation audio as output of the de-reverberation model.

In an embodiment, the audio content feature includes a music style; and the determining a content-adaptive masking matrix based on the audio content feature includes:
determining, based on a music style detection probability at a current time point and suppression coefficients at different frequencies, a reverberation weighted weight related to a music style at the current time point.

In an embodiment, the audio content feature includes drumbeat intensity; and the determining a content-adaptive masking matrix based on the audio content feature includes:
determining, based on the drumbeat intensity at a current time point and a corresponding frequency, a reverberation weighted weight related to a drumbeat at the current time point by using a monotonically decreasing reverberation weight calculation function.

In an embodiment, the audio content feature includes a reverberation degree, the reverberation degree being represented by a time-frequency masking matrix; and the determining a content-adaptive masking matrix based on the audio content feature includes:
determining, based on a masking value in the time-frequency masking matrix corresponding to a current time-frequency point, a reverberation weighted weight related to a reverberation degree at the current time-frequency point by using a monotonically increasing reverberation weight calculation function.

In an embodiment, when the input audio signal includes a plurality of audio content features, the determining a content-adaptive masking matrix based on the audio content feature includes:
determining a reverberation masking matrix corresponding to each of the audio content features respectively; and
combining the reverberation masking matrixes corresponding to the audio content features to obtain the content-adaptive masking matrix of the input audio signal.

A second aspect of the present disclosure provides an audio reverberation system. The audio reverberation system includes:
a preprocessing module configured to preprocess an input audio signal to obtain a reverberation input signal;
a reverberation generation module configured to reverberation the reverberation input signal to generate an initial reverberation audio signal of a target scene;
an audio content analysis module configured to perform audio content analysis on the input audio signal to obtain an audio content feature corresponding to the input audio signal;
a content-adaptive masking module configured to determine a content-adaptive masking matrix based on the audio content feature;
a content-adaptive reverberation module configured to perform weighted mixing on the content-adaptive masking matrix and the initial reverberation audio signal to obtain a content-adaptive reverberation signal; and
a mixing module configured to perform weighted mixing on the content-adaptive reverberation signal and the reverberation input signal according to a preset ratio to obtain a final reverberation audio signal.

In an embodiment, the audio content feature includes a music style; and that the audio content analysis module is configured to perform audio content analysis on the input audio signal to obtain an audio content feature of the input audio signal includes:
the audio content analysis module being configured to:
obtain the music style of the input audio signal based on an audio tag of the input audio signal; or
obtain an audio feature based on a music spectrum of the input audio signal, and input the audio feature into a pre-trained music classification model to obtain the music style of the input audio signal; wherein the music classification model is trained by using audio features and corresponding classification tags.

In an embodiment, the audio content feature includes drumbeat intensity; and that the audio content analysis module is configured to perform audio content analysis on the input audio signal to obtain an audio content feature of the input audio signal includes:
the audio content analysis module being configured to:
determine abrupt change points of the input audio signal based on a note onsets detection scheme by using energy or spectrum change information, take the abrupt change points whose abrupt change degrees are greater than a preset abrupt change threshold as drumbeats, and obtain the drumbeat intensity of the input audio signal based on a number of the drumbeats in a preset duration; or
input a multi-frame spectrum of the input audio signal into a pre-trained drumbeat detection model to obtain probabilities of respective time points corresponding to drumming sounds, take the time points with the probabilities greater than a preset probability threshold as drumbeats, and obtain the drumbeat intensity of the input audio signal based on a number of the drumbeats in a preset duration.

In an embodiment, the audio content feature includes a reverberation degree; and that the audio content analysis module is configured to perform audio content analysis on the input audio signal to obtain an audio content feature of the input audio signal includes,
the audio content analysis module being configured to:
input a signal spectrum of the input audio signal into a pre-trained de-reverberation model to obtain a time-frequency masking matrix corresponding to de-reverb; or
perform dry sound and wet sound separation on the signal spectrum of the input audio signal, and take a ratio of a signal spectrum of dry sounds obtained by separation to the signal spectrum of the input audio signal as a time-frequency masking matrix;
wherein the time-frequency masking matrix is used to represent the reverberation degree of each time-frequency point.

In an embodiment, the audio reverberation system further includes:
a model training module configured to train the de-reverberation model according to the following steps:
acquiring a clean audio and a reverberation audio thereof, and training the de-reverberation model by using a reverberation audio spectrum of the reverberation audio as input of the de-reverberation model and the time-frequency masking matrix corresponding to the de-reverberation as output of the de-reverberation model; or
acquiring a clean audio and a reverberation audio thereof, generating a first target artificial reverberation audio based on the clean audio, and generating a second target artificial reverberation audio based on the reverberation audio; and training the de-reverberation model by using the reverberation audio as input of the de-reverberation model and a time-frequency masking matrix corresponding to a ratio of the first target artificial reverberation audio to the second target artificial reverberation audio as output of the de-reverberation model.

In an embodiment, the audio content feature includes a music style; and that the content-adaptive masking module is configured to determine a content-adaptive masking matrix based on the audio content feature includes:
the content-adaptive masking module being configured to:
determine, based on a music style detection probability at a current time point and suppression coefficients at different frequencies, a reverberation weighted weight related to a music style at the current time point.

In an embodiment, the audio content feature includes drumbeat intensity; and that the content-adaptive masking module is configured to determine a content-adaptive masking matrix based on the audio content feature includes:
the content-adaptive masking module being configured to:
determine, based on the drumbeat intensity at a current time point and a corresponding frequency, a reverberation weighted weight related to a drumbeat at the current time point by using a monotonically decreasing reverberation weight calculation function.

In an embodiment, the audio content feature includes a reverberation degree, the reverberation degree being represented by a time-frequency masking matrix; and that the content-adaptive masking module is configured to determine a content-adaptive masking matrix based on the audio content feature includes:
the content-adaptive masking module being configured to:
determine, based on a masking value in the time-frequency masking matrix corresponding to a current time-frequency point, a reverberation weighted weight related to a reverberation degree at the current time-frequency point by using a monotonically increasing reverberation weight calculation function.

In an embodiment, when the input audio signal includes a plurality of audio content features, that the content-adaptive masking module is configured to determine a content-adaptive masking matrix based on the audio content feature includes:
the content-adaptive masking module being configured to:
determine a reverberation masking matrix corresponding to each of the audio content features respectively; and
combine the reverberation masking matrixes corresponding to the audio content features to obtain the content-adaptive masking matrix of the input audio signal.

Compared with the related art, in the present disclosure, an input audio signal is preprocessed to obtain a reverberation input signal, the reverberation input signal is reverbed to generate an initial reverberation audio signal of a target scene, audio content analysis is performed on the input audio signal to obtain a corresponding audio content feature, a content-adaptive masking matrix is determined based on the audio content feature, weighted mixing is performed on the content-adaptive masking matrix and the initial reverberation audio signal to obtain a content-adaptive reverberation signal, and weighted mixing is performed on the content-adaptive reverberation signal and the reverberation input signal according to a preset ratio to obtain a final reverberation audio signal, which adapts audio signals with different audio content to different reverberation effects, avoiding the problem of distortion of the final reverberation audio signal.

### BRIEF DESCRIPTION OF DRAWINGS

One or more embodiments will be illustrated with reference to the accompanying drawings corresponding thereto. These illustrations do not constitute limitations on the embodiments. In the companying drawing, elements with like reference numbers refer to like or similar elements. Unless specifically stated, the drawings in the accompanying drawings do not constitute a scale limitation.

FIG. 1 is a flowchart of an audio reverberation method according to an embodiment of the present disclosure; and

FIG. 2 is a structural schematic diagram of an audio reverberation system according to another embodiment of the present disclosure.

### DESCRIPTION OF EMBODIMENTS

To make the objectives, technical solutions, and advantages of embodiments of the present disclosure clearer, the embodiments of the present disclosure will be described in detail below with reference to the accompanying drawings. However, it is to be understood by those skilled in the art that, in the various embodiments of the present disclosure, numerous technical details are set forth in order to provide a reader with a better understanding of the present disclosure. However, even without these technical details and various changes and modifications based on the following embodiments, the technical solutions claimed in the present disclosure may still be implemented. The following divisions of the various embodiments are for convenience of description and should not constitute any limitation on the specific implementation of the present disclosure. The various embodiments can be combined with each other and referenced to each other provided there is no contradiction.

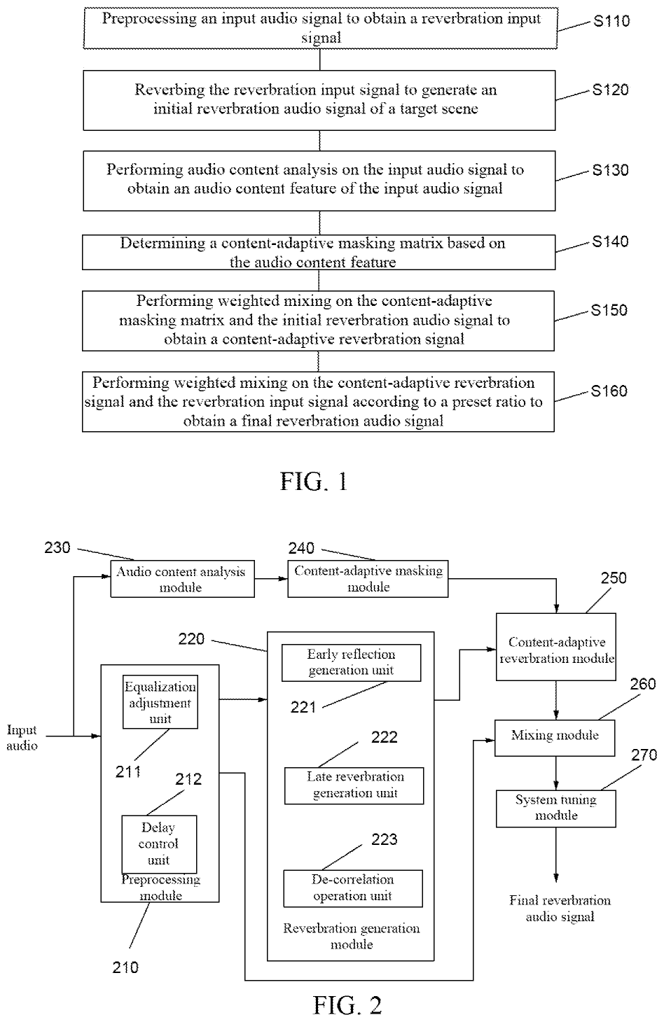

The present disclosure provides an audio reverberation method. A process of the audio reverberation method is shown in FIG. 1, including the following steps.

In step S110, an input audio signal is preprocessed to obtain a reverberation input signal. In an embodiment, the preprocessing may include EQ adjustment, that is, equalization adjustment, to adjust loudness and timbre of respective frequency bands in the input audio signal. The preprocessing may further include delay control, so that audio signals in a plurality of frequency bands can meet corresponding delay requirements at the same time. Certainly, the preprocessing may further include other operations besides equalization adjustment and delay control, which may be selected and set by those skilled in the art according to an actual requirement.

In step S120, the reverberation input signal is reverbed to generate an initial reverberation audio signal of a target scene.

Generally, reverberation is usually divided into early reflection and late reverberation according to a time difference between direct sound (that is, an audio signal transmitted directly from a sound source to a sound collection device) and reverberation transmitted to the sound collection device. For example, reverberation that reaches the sound collection device within 30 milliseconds after the direct sound may be regarded as early reflection, and reverberation that reaches the sound collection device more than 30 milliseconds may be regarded as late reverberation. Therefore, the reverbing may include generating early reflection and late reverberation to respectively generate an early reflection analog signal and a late reverberation analog signal of the target scene, the early reverberation analog signal and the late reverberation analog signal are blended to the reverberation input signal, and a De-correlation operation is performed on a blended signal, thereby obtaining the initial reverberation audio signal of the target scene. The De-correlation operation may include, but is not limited to, addition/subtraction of delay and scaling of a source signal.

In step S130, audio content analysis is performed on the input audio signal to obtain an audio content feature of the input audio signal. In an embodiment, the audio content feature may include, but is not limited to, types such as a music style, drumbeat intensity, and a reverberation degree at each time-frequency point of an audio. For different types of audio content features, those skilled in the art may use different analysis methods to perform audio content analysis on the input audio signal, which is not limited in this embodiment.

In step S140, a content-adaptive masking matrix is determined based on the audio content feature. In an embodiment, the content-adaptive masking matrix may be a two-dimensional matrix used to represent weighted weights of different audio content features corresponding to each time-frequency point. The content-adaptive masking matrix may be a weighted weight for a certain type of audio content features alone, for example, a weighted weight for any one of the music style, the drumbeat intensity, and the reverberation degree, or a weighted weight for a combination of a plurality of types of audio content features, for example, a weighted weight for a combination of the music style and the drumbeat intensity, or a weighted weight for a combination of the music style and the reverberation degree, or a weighted weight for a combination of the drumbeat intensity and the reverberation degree, or a weighted weight for a combination of the music style, the drumbeat intensity, and the reverberation degree, or the like.

In step S150, weighted mixing is performed on the content-adaptive masking matrix and the initial reverberation audio signal to obtain a content-adaptive reverberation signal. In an embodiment, in step S150, firstly, a short-time Fourier transform (STFT) operation may be performed on the initial reverberation audio signal to obtain an initial reverberation signal spectrum, then, the initial reverberation signal spectrum is multiplied by the content-adaptive masking matrix to obtain a content-adaptive reverberation spectrum after weighted mixing, and then an inverse short-time Fourier transform (ISTFT) is performed on the content-adaptive reverberation spectrum to obtain the content-adaptive reverberation signal.

It is to be noted that, before the initial reverberation signal spectrum is multiplied by the content-adaptive masking matrix, the content-adaptive masking matrix may also be smoothed in time and frequency dimensions in advance, so as to multiply the initial reverberation signal spectrum by the smoothed content-adaptive masking matrix, thereby avoiding an excessively quick change in the reverberation after weighted mixing.

Certainly, in this embodiment, a manner of weighted mixing the content-adaptive masking matrix and the initial reverberation audio signal is not limited. Those skilled in the art may alternatively perform weighted mixing on the content-adaptive masking matrix and the initial reverberation audio signal in other manners, as long as the content-adaptive reverberation signal can be obtained by weighted mixing on the content-adaptive masking matrix and the initial reverberation audio signal.

In step S160, weighted mixing is performed on the content-adaptive reverberation signal and the reverberation input signal according to a preset ratio to obtain a final reverberation audio signal. In an embodiment, the preset ratio may be set according to an actual requirement. For example, the preset ratio may be 1:1, 1.1:0.8, 0.7:1.2, or the like.

It is to be noted that, after the final reverberation audio signal is obtained, adjustment operations such as delay control and gain control may also be performed on the final reverberation audio signal to meet an actual requirement.

Compared with the related art, according to the audio reverberation method provided in this embodiment of the present disclosure, an input audio signal is preprocessed to obtain a reverberation input signal, the reverberation input signal is reverbed to generate an initial reverberation audio signal of a target scene, audio content analysis is performed on the input audio signal to obtain a corresponding audio content feature, a content-adaptive masking matrix is determined based on the audio content feature, weighted mixing is performed on the content-adaptive masking matrix and the initial reverberation audio signal to obtain a content-adaptive reverberation signal, and weighted mixing is performed on the content-adaptive reverberation signal and the reverberation input signal according to a preset ratio to obtain a final reverberation audio signal, which adapts audio signals with different audio content to different reverberation effects, avoiding the problem of distortion of the final reverberation audio signal.

In an embodiment, the audio content feature includes a music style. The music style is also called a music type, which may include, but is not limited to, pop, rock, folk, electronic music, and the like.

When the input audio signal carries an audio tag indicating a music style thereof, step S130 may include: obtaining the music style of the input audio signal based on the audio tag of the input audio signal. That is, step S130 may include directly acquiring a music style corresponding thereto from the audio tag carried in the input audio signal, so as to quickly and accurately obtain the music style of the input audio signal.

For the audio content feature of the music style, step S130 may alternatively include automatically acquiring the music style of the input audio signal by using a neural network-based music classification model.

For example, step S130 may include: obtaining an audio feature based on a music spectrum of the input audio signal, and inputting the audio feature into a pre-trained music classification model to obtain the music style of the input audio signal. The music classification model is trained by using audio features and corresponding classification tags.

In an embodiment, in step S130, the input audio signal may be divided into several music clips of specific durations (such as 3 seconds), a music spectrum of each music clip is obtained through an STFT operation, then corresponding audio features, such as a Mel frequency cepstrum coefficient (MFCC), a chromaticity feature, and a spectral contrast, are extracted from the music spectrum of each music clip, and the extracted audio features of each music clip are inputted to the pre-trained music classification model respectively to obtain a music style of each music clip, thereby obtaining the music style of the input audio signal. Certainly, in step S130, when the input audio signal is divided into several music clips of specific durations, the durations of the music clips may be the same or different, which is not limited in this embodiment.

It is to be noted that a specific type of the music classification model is not limited in this embodiment. For example, the music classification model may be a convolutional neural network (CNN), a long short-term memory (LSTM) network, or the like. In a training stage of the music classification model, audio features of a large number of music clips and corresponding music classification tags may be used as training data, and the music classification model is trained by using the training data. In the training stage of the music classification model, the music classification model may be tested by taking audio features of a tested audio clip as input of the music classification model and a music style detection probability P corresponding to the tested audio clip as output of the music classification model. The music style detection probability P is expressed as P=[p1,p2, . . . ,pK], p1+p2+ . . . +pK=1, p1, p2, . . . , and pK denote detection probabilities corresponding to music styles 1, 2, . . . , and K, and K denotes a number of types of the music styles.

The music style of the input audio signal is acquired by using the pre-trained music classification model, which can effectively improve accuracy of determination of the music style of the input audio signal.

In an embodiment, the audio content feature includes drumbeat intensity. When audio content analysis is performed on the input audio signal, in step S130, the drumbeat intensity of the input audio signal may be obtained in two manners. In one manner, the drumbeat intensity of the input audio signal is obtained by using a note onsets detection scheme. In the other manner, the drumbeat intensity of the input audio signal is obtained by using a pre-trained neural network-based drumbeat detection model.

When the drumbeat intensity of the input audio signal is obtained by using the note onsets detection scheme, step S130 may include: determining abrupt change points of the input audio signal based on the note onsets detection scheme by using energy or spectrum change information, taking the abrupt change points whose abrupt change degrees are greater than a preset abrupt change threshold as drumbeats, and obtaining the drumbeat intensity of the input audio signal based on a number of the drumbeats in a preset duration.

In an embodiment, one characteristic of note onsets is a sudden increase in energy or a change in spectral energy distribution. According to the characteristic of the note onsets, respective abrupt change points in the input audio signal can be determined. It is to be noted that specific steps of the note onsets detection scheme are not limited in this embodiment, as long as the abrupt change points of the input audio signal can be determined by using the energy or spectrum change information.

The drumbeat intensity of the input audio signal may be represented by drumbeat density of the input audio signal per unit time. The preset duration is denoted as T, and a sliding window with a duration of T is used. When a number of drumbeats in the sliding window is N, the drumbeat density D of the input audio signal per unit time is D=N/T.

A specific value of the preset abrupt change threshold may be set according to an actual requirement. In this embodiment, the preset abrupt change threshold is used as a standard for selecting drumbeats from the abrupt change points, and only the abrupt change points whose abrupt change degrees are greater than the preset abrupt change threshold are taken as drumbeats, which improves accuracy of drumbeat detection, thereby improving accuracy of determination of the drumbeat intensity.

When the drumbeat intensity of the input audio signal is obtained by using the pre-trained neural network-based drumbeat detection model, step S130 may include: inputting a multi-frame spectrum of the input audio signal into a pre-trained drumbeat detection model to obtain probabilities of respective time points corresponding to drumming sounds, taking the time points with the probabilities greater than a preset probability threshold as drumbeats, and obtaining the drumbeat intensity of the input audio signal based on a number of the drumbeats in a preset duration.

In an embodiment, the drumbeat detection model may be established based on a deep neural network. For example, the drumbeat detection model may include a multi-stage temporal convolutional network and a classifier. Each temporal convolutional network may include a convolutional layer, a batch normalization layer, an activation layer, a residual convolutional layer, and the like. Certainly, a specific network structure of the drumbeat detection model is not limited in this embodiment, which may be set by those skilled in the art according to an actual requirement, as long as the probabilities of the respective time points corresponding to the drumming sounds can be obtained on the basis of the multi-frame spectrum of the input audio signal by using the pre-trained drumbeat detection model.

It is to be noted that the probabilities of the respective time points corresponding to the drumming sounds refers to probabilities indicating whether audio signals at the respective time point are drumbeats. A value of the preset probability threshold may be set according to an actual requirement. The preset probability threshold is used as a standard for selecting drumbeats from the respective time points, and only the time points whose probabilities corresponding to drumbeats are greater than the preset probability threshold are taken as drumbeats, which improves accuracy of drumbeat detection, thereby improving accuracy of determination of the drumbeat intensity.

In an embodiment, the audio content feature includes a reverberation degree. The reverberation degree at each time-frequency point may be represented by a time-frequency masking matrix. When audio content analysis is performed on the input audio signal, in step S130, the time-frequency masking matrix of the input audio signal may be determined in two manners. In one manner, a pre-trained de-reverberation model is used for implementation. In the other manner, a dry and wet sound separation manner is used for implementation.

When the pre-trained de-reverberation model is used for implementation, step S130 may include: inputting a signal spectrum of the input audio signal into the pre-trained de-reverberation model to obtain a time-frequency masking matrix corresponding to de-reverberation.

In an embodiment, the de-reverberation model may be established based on a neural network. A specific network structure of the de-reverberation model is not limited in this embodiment, as along as the time-frequency masking matrix corresponding to de-reverberation can be obtained based on the signal spectrum of the input audio signal by using the pre-trained de-reverberation model.

The de-reverberation model may be trained in two manners.

In the first training manner, the pre-trained de-reverberation model is trained according to the following steps:
acquiring a clean audio and a reverberation audio thereof, and training the de-reverberation model by using a reverberation audio spectrum of the reverberation audio as input of the de-reverberation model and the time-frequency masking matrix corresponding to the de-reverberation as output of the de-reverberation model.

In an embodiment, the reverberation audio refers to a reverberation audio obtained by superimposing reverberation data on the clean audio. A large number of clean audios and reverberation audios thereof form data pairs as training data. In a model training stage, a reverberation audio spectrum Y of the reverberation audio is taken as input of the de-reverberation model, a time-frequency masking matrix M corresponding to de-reverberation of the reverberation audio spectrum Y is taken as output of the de-reverberation model, and a de-reverberation audio spectrum X′ corresponding to a de-reverberation audio obtained by de-reverbing the reverberation audio spectrum Y is X′=Y*M. The de-reverberation model can be trained by minimizing an error of a clean audio spectrum X of the clean audio and a de-reverberation audio spectrum X′ of the clean audio and iterating continuously with training data. In the model training stage, a time-frequency masking matrix corresponding to de-reverberation of a tested audio signal spectrum can be obtained by taking the tested audio signal spectrum as input of the de-reverberation model. The time-frequency masking matrix outputted by the de-reverberation model trained based on this training manner is a weighted weight of artificial reverberation.

In the second training manner, the pre-trained de-reverberation model is trained according to the following steps:
acquiring a clean audio and a reverberation audio thereof, generating a first target artificial reverberation audio based on the clean audio, and generating a second target artificial reverberation audio based on the reverberation audio; and training the de-reverberation model by using the reverberation audio as input of the de-reverberation model and a time-frequency masking matrix corresponding to a ratio of the first target artificial reverberation audio to the second target artificial reverberation audio as output of the de-reverberation model. The time-frequency masking matrix outputted by the de-reverberation model trained based on this training manner is a weighted weight required for ideal artificial reverberation.

The time-frequency masking matrix representing the reverberation degree at each time-frequency point is acquired by using the de-reverberation model, which can effectively improve accuracy of determination of the time-frequency masking matrix.

When the dry and wet sound separation manner is used for implementation, step S130 may include: performing dry sound and wet sound separation on the signal spectrum of the input audio signal, and taking a ratio of a signal spectrum of dry sounds obtained by separation to the signal spectrum of the input audio signal as a time-frequency masking matrix.

In an embodiment, for a multi-channel input audio signal Y, a principal component analysis (PCA) method may be used for dry sound Y_dry and wet sound Y_wet separation, and Y_dry/Y is a time-frequency masking matrix corresponding to de-reverberation of an input audio signal Y.

The time-frequency masking matrix corresponding to de-reverberation of the input audio signal is acquired by dry and wet separation, which can effectively improve the accuracy of determination of the time-frequency masking matrix corresponding to the multi-channel input audio signal.

In an embodiment, when the audio content feature includes a music style, step S140 may include: determining, based on a music style detection probability at a current time point and suppression coefficients at different frequencies, a reverberation weighted weight related to a music style at the current time point.

In an embodiment, different reverberation weighted coefficients may be set in advance for different music styles. For example, for a music style k, a reverberation weighted coefficient corresponding thereto is denoted as ak, and ak is in a value range of [0, 1]. When a number of types of music styles is K, k is in a value range of 1, 2, . . . , and K, and reverberation weighted coefficients corresponding to the music styles form a reverberation weighted coefficient set A=[a1,a2, . . . , aK], where a1, a2, . . . , and aK denote reverberation weighted coefficients corresponding to the music styles 1, 2, . . . , and K respectively.

For a specific time point t, assuming that a current music style detection probability thereof is P(t), a reverberation weighted weight W1(t) related to a music style at the time point t may be expressed as W1(t)=A*P(t)=a1*p1(t)+a2*p2(t)+ . . . +aK*pK(t). p1(t), p2(t), . . . , and pK(t) denote detection probabilities corresponding to the music styles 1, 2, . . . , and K at the time point t respectively.

For different music styles, different suppression coefficients may be set at different frequencies. For example, suppression coefficients a1(f), a2(f), . . . , and aK(f) corresponding to the music styles 1, 2, . . . , and K at a corresponding frequency f may form a suppression coefficient set A(f). A(f) is expressed as A(f)=[a1(f),a2(f), . . . ,aK(f)]. On this basis, a reverberation weighted weight W1(t,f) related to a music style at a time-frequency point (t,f) may be expressed as W1(t,f)=A(f)*P(t)=a1(f)*p1(t)+a2(f)*p2(t)+ . . . +aK(f)*pK(t).

In this embodiment, reverberation weighted weights related to music styles are determined through suppression coefficients at different frequencies, and reverberation adaptation effects of audio signals of different music styles can be further improved by using the reverberation weighted weights.

In an embodiment, the audio content feature includes drumbeat intensity. Step S140 includes: determining, based on the drumbeat intensity at a current time point and a corresponding frequency, a reverberation weighted weight related to a drumbeat at the current time point by using a monotonically decreasing reverberation weight calculation function.
In an embodiment, for a specific time point t, current drumbeat intensity thereof is denoted as D(t), and a reverberation weighted weight W2(t) related to a drumbeat at the time point t may be expressed as W2(t)=Fd(D(t)). Fd( ) denotes a monotonically decreasing reverberation weight calculation function based on drumbeat density. If drumbeat intensity at the time point t is higher, an artificial reverberation weighted weight corresponding thereto is lower, and the audio corresponds to less reverberation.

At different frequencies, the reverberation weighted weights related to drumbeats may be different. For a time-frequency point (t,f), a reverberation weighted weight W2(t,f) related to a drumbeat may be expressed as W2(t,f)=Fd(D(t),f).

It is to be noted that a specific form of the monotonically decreasing reverberation weight calculation function is not limited in this embodiment, as long as the reverberation weight calculation function satisfies monotonic decreasing.

In this embodiment, the reverberation weighted weight related to the drumbeat is determined by using the monotonically decreasing reverberation weight calculation function, and reverberation adaptation effects of audio signals with different drumbeat intensity can be further improved by using the reverberation weighted weight.

In an embodiment, the audio content feature includes a reverberation degree, and the reverberation degree is represented by a time-frequency masking matrix. Step S140 includes: determining, based on a masking value in the time-frequency masking matrix corresponding to a current time-frequency point, a reverberation weighted weight related to a reverberation degree at the current time-frequency point by using a monotonically increasing reverberation weight calculation function.

In an embodiment, for a specific time-frequency point (t,f), in step S140, when a reverberation weighted weight related to a reverberation degree thereof is determined, a masking value M(t,f) in a time-frequency masking matrix corresponding to the time-frequency point (t,f) may be obtained through a preset neural network. Then, an artificial reverberation weighted weight W3(t,f) related to the reverberation degree corresponding to the time-frequency point (t,f) may be expressed as W3(t,f)=Fr(M(t,f)), where Fr( ) denotes a monotonically increasing reverberation weight calculation function based on the reverberation degree. If the masking value in the time-frequency masking matrix corresponding to the time-frequency point (t, f) is lower, it indicates that the reverberation degree of the corresponding audio thereof is higher, and an artificial reverberation weighted weight required to be superimposed is lower. In particular, when the time-frequency masking matrix corresponds to the weighted weight required for ideal artificial reverberation, Fr(M(t,f))=M(t,f).

It is to be noted that a specific manner of acquiring the masking value in the time-frequency masking matrix corresponding to the current time-frequency point is not limited in this embodiment, as long as the masking value in the time-frequency masking matrix corresponding to the current time-frequency point can be obtained. A specific form of the monotonically increasing reverberation weight calculation function is not limited in this embodiment, as long as the reverberation weight calculation function satisfies monotonic increasing.

In this embodiment, a reverberation weighted weight related to a reverberation degree is determined by using the monotonically increasing reverberation weight calculation function, and reverberation adaptation effects of audio signals with different reverberation degrees can be further improved by using the reverberation weighted weight.

In an embodiment, when the input audio signal includes a plurality of audio content features, step S140 includes: determining a reverberation masking matrix corresponding to each of the audio content features respectively; and combining the reverberation masking matrixes corresponding to the audio content features to obtain the content-adaptive masking matrix of the input audio signal.

For example, when the plurality of audio content features included in the input audio signal are a music style, drumbeat intensity, and a reverberation degree, in step S140, firstly, a reverberation masking matrix related to a music style at a current time-frequency point (t,f), i.e., a reverberation weighted weight W1(t,f), a reverberation masking matrix related to a drumbeat, i.e., a reverberation weighted weight W2(t,f), and a reverberation masking matrix related to a reverberation degree, i.e., a reverberation weighted weight W3(t,f) may be obtained respectively, and then, the reverberation weighted weights are combined to obtain a content-adaptive masking matrix W(t,f) at the current time-frequency point (t,f). W(t,f) may be expressed as W(t,f)=W1(t,f)*W2(t,f)*W3(t,f).

Reverberation adaptation effects of audio signals with different music content can be further improved by combining the reverberation masking matrixes corresponding to the audio content features.

Another embodiment of the present disclosure relates to an audio reverberation system, which, as shown in FIG. 2, includes:
a preprocessing module 210 configured to preprocess an input audio signal to obtain a reverberation input signal;
a reverberation generation module 220 configured to reverberation the reverberation input signal to generate an initial reverberation audio signal of a target scene;
an audio content analysis module 230 configured to perform audio content analysis on the input audio signal to obtain an audio content feature corresponding to the input audio signal;
a content-adaptive masking module 240 configured to determine a content-adaptive masking matrix based on the audio content feature;
a content-adaptive reverberation module 250 configured to perform weighted mixing on the content-adaptive masking matrix and the initial reverberation audio signal to obtain a content-adaptive reverberation signal; and
a mixing module 260 configured to perform weighted mixing on the content-adaptive reverberation signal and the reverberation input signal according to a preset ratio to obtain a final reverberation audio signal.

In an embodiment, as shown in FIG. 2, the preprocessing module 210 may further include an equalization adjustment unit 211, so as to use the equalization adjustment unit 211 to perform equalization adjustment to adjust loudness and timbre of respective frequency bands in the input audio signal. The preprocessing module 210 may further include a delay control unit 212, so as to use the delay control unit 212 to perform delay control, so that audio signals in a plurality of frequency bands can meet corresponding delay requirements at the same time. The preprocessing module 210 may further include other units besides the equalization adjustment unit 211 and the delay control unit 212, which may be selected and set by those skilled in the art according to an actual requirement.

As shown in FIG. 2, the reverberation generation module 220 may include an early reflection generation unit 221, a late reverberation generation unit 222, and a De-correlation operation unit 223. The early reflection generation unit 221 and the late reverberation generation unit 222 are configured to generate early reflection and late reverberation respectively to generate an early reflection analog signal and a late reverberation analog signal of the target scene respectively, the early reverberation analog signal and the late reverberation analog signal are blended to the reverberation input signal, and a De-correlation operation such as addition/subtraction of delay and scaling of a source signal is performed on a blended signal by using the De-correlation operation unit 223, thereby obtaining the initial reverberation audio signal of the target scene.

Compared with the related art, according to the audio reverberation system provided in the embodiments of the present disclosure, an input audio signal is preprocessed by the preprocessing module to obtain a reverberation input signal, the reverberation input signal is reverbed by the reverberation generation module to generate an initial reverberation audio signal of a target scene, audio content analysis is performed on the input audio signal by the audio content analysis module to obtain a corresponding audio content feature, a content-adaptive masking matrix is determined based on the audio content feature by the content-adaptive masking module, weighted mixing is performed on the content-adaptive masking matrix and the initial reverberation audio signal by the content-adaptive reverberation module to obtain a content-adaptive reverberation signal, and weighted mixing is performed on the content-adaptive reverberation signal and the reverberation input signal according to a preset ratio by the mixing module to obtain a final reverberation audio signal, which adapts audio signals with different audio content to different reverberation effects, avoiding the problem of distortion of the final reverberation audio signal.

In an embodiment, the audio content feature includes a music style.

That the audio content analysis module 230 is configured to perform audio content analysis on the input audio signal to obtain an audio content feature corresponding to the input audio signal includes:
the audio content analysis module 230 being configured to obtain the music style of the input audio signal based on an audio tag of the input audio signal; or obtain an audio feature based on a music spectrum of the input audio signal, and input the audio feature into a pre-trained music classification model to obtain the music style of the input audio signal. The music classification model is trained by using audio features and corresponding classification tags.

In an embodiment, the audio content feature includes drumbeat intensity.

That the audio content analysis module 230 is configured to perform audio content analysis on the input audio signal to obtain an audio content feature corresponding to the input audio signal includes:
the audio content analysis module 230 being configured to determine abrupt change points of the input audio signal based on a note onsets detection scheme by using energy or spectrum change information, take the abrupt change points whose abrupt change degrees are greater than a preset abrupt change threshold as drumbeats, and obtain the drumbeat intensity of the input audio signal based on a number of the drumbeats in a preset duration; or input a multi-frame spectrum of the input audio signal into a pre-trained drumbeat detection model to obtain probabilities of respective time points corresponding to drumming sounds, take the time points with the probabilities greater than a preset probability threshold as drumbeats, and obtain the drumbeat intensity of the input audio signal based on a number of the drumbeats in a preset duration.

In an embodiment, the audio content feature includes a reverberation degree.

That the audio content analysis module 230 is configured to perform audio content analysis on the input audio signal to obtain an audio content feature corresponding to the input audio signal includes:
the audio content analysis module 230 being configured to input a signal spectrum of the input audio signal into a pre-trained de-reverberation model to obtain a time-frequency masking matrix corresponding to de-reverb; or perform dry sound and wet sound separation on the signal spectrum of the input audio signal, and take a ratio of a signal spectrum of dry sounds obtained by separation to the signal spectrum of the input audio signal as a time-frequency masking matrix. The time-frequency masking matrix is used to represent the reverberation degree of each time-frequency point.

In an embodiment, the audio reverberation system further includes:
a model training module configured to train the de-reverberation model according to the following steps:
acquiring a clean audio and a reverberation audio thereof, and training the de-reverberation model by using a reverberation audio spectrum of the reverberation audio as input of the de-reverberation model and the time-frequency masking matrix corresponding to the de-reverberation as output of the de-reverberation model; or
acquiring a clean audio and a reverberation audio thereof, generating a first target artificial reverberation audio based on the clean audio, and generating a second target artificial reverberation audio based on the reverberation audio; and training the de-reverberation model by using the reverberation audio as input of the de-reverberation model and a time-frequency masking matrix corresponding to a ratio of the first target artificial reverberation audio to the second target artificial reverberation audio as output of the de-reverberation model.

In an embodiment, the audio content feature includes a music style.

That the content-adaptive masking module 240 is configured to determine a content-adaptive masking matrix based on the audio content feature includes:
the content-adaptive masking module 240 being configured to determine, based on a music style detection probability at a current time point and suppression coefficients at different frequencies, a reverberation weighted weight related to a music style at the current time point.

In an embodiment, the audio content feature includes drumbeat intensity.

That the content-adaptive masking module 240 is configured to determine a content-adaptive masking matrix based on the audio content feature includes:
the content-adaptive masking module 240 being configured to determine, based on the drumbeat intensity at a current time point and a corresponding frequency, a reverberation weighted weight related to a drumbeat at the current time point by using a monotonically decreasing reverberation weight calculation function.

In an embodiment, the audio content feature includes a reverberation degree, and the reverberation degree is represented by a time-frequency masking matrix.

That the content-adaptive masking module 240 is configured to determine a content-adaptive masking matrix based on the audio content feature includes:
the content-adaptive masking module 240 being configured to determine, based on a masking value in the time-frequency masking matrix corresponding to a current time-frequency point, a reverberation weighted weight related to a reverberation degree at the current time-frequency point by using a monotonically increasing reverberation weight calculation function.

In an embodiment, when the input audio signal includes a plurality of audio content features, that the content-adaptive masking module 240 is configured to determine a content-adaptive masking matrix based on the audio content feature includes:
the content-adaptive masking module 240 being configured to determine a reverberation masking matrix corresponding to each of the audio content features respectively; and combine the reverberation masking matrixes corresponding to the audio content features to obtain the content-adaptive masking matrix of the input audio signal.

In an embodiment, as shown in FIG. 2, the audio reverberation system further includes a system tuning module 270. The system tuning module 270 is configured to perform adjustment operations such as delay control and gain control on the final reverberation audio signal obtained by the mixing module, so as to output an adjusted final reverberation audio signal that meets an actual requirement.

A specific implementation method for the audio reverberation system provided in the embodiments of the present disclosure may be obtained with reference to the description in the audio reverberation method provided in the embodiments of the present disclosure. Details are not described herein again.

Those of ordinary skill in the art may understand that the above embodiments are specific implementations for implementing the present disclosure, and in actual applications, various changes may be made in form and details without departing from the spirit and scope of the present disclosure.

What is claimed is:

1. An audio reverberation method, comprising:
preprocessing an input audio signal to obtain a reverberation input signal;
reverbing the reverberation input signal to generate an initial reverberation audio signal of a target scene;
performing audio content analysis o′n the input audio signal to obtain an audio content feature of the input audio signal;
determining a content-adaptive masking matrix based on the audio content feature;
performing weighted mixing on the content-adaptive masking matrix and the initial reverberation audio signal to obtain a content-adaptive reverberation signal; and
performing weighted mixing on the content-adaptive reverberation signal and the reverberation input signal according to a preset ratio to obtain a final reverberation audio signal.

2. The audio reverberation method as described in claim 1, wherein the audio content feature comprises a music style; and the performing audio content analysis on the input audio signal to obtain the audio content feature of the input audio signal comprises:
obtaining the music style of the input audio signal based on an audio tag of the input audio signal; or
obtaining an audio feature based on a music spectrum of the input audio signal, and inputting the audio feature into a pre-trained music classification model to obtain the music style of the input audio signal, wherein the music classification model is trained by using audio features and corresponding classification tags.

3. The audio reverberation method as described in claim 1, wherein the audio content feature comprises drumbeat intensity; and the performing audio content analysis on the input audio signal to obtain the audio content feature of the input audio signal comprises:
determining abrupt change points of the input audio signal based on a note onsets detection scheme by using energy or spectrum change information, taking the abrupt change points whose abrupt change degrees are greater than a preset abrupt change threshold as drumbeats, and obtaining the drumbeat intensity of the input audio signal based on a number of the drumbeats in a preset duration; or
inputting a multi-frame spectrum of the input audio signal into a pre-trained drumbeat detection model to obtain probabilities of respective time points corresponding to drumming sounds, taking the time points with the probabilities greater than a preset probability threshold as drumbeats, and obtaining the drumbeat intensity of the input audio signal based on a number of the drumbeats in a preset duration.

4. The audio reverberation method as described in claim 1, wherein the audio content feature comprises a reverberation degree; and the performing audio content analysis on the input audio signal to obtain the audio content feature of the input audio signal comprises:
inputting a signal spectrum of the input audio signal into a pre-trained de-reverberation model to obtain a time-frequency masking matrix corresponding to de-reverb; or
performing dry sound and wet sound separation on the signal spectrum of the input audio signal, and taking a ratio of a signal spectrum of dry sounds obtained by separation to the signal spectrum of the input audio signal as a time-frequency masking matrix;
wherein the time-frequency masking matrix is used to represent the reverberation degree of each time-frequency point.

5. The audio reverberation method as described in claim 4, wherein the pre-trained de-reverberation model is obtained by according to the following training steps:
acquiring a clean audio and a reverberation audio thereof, and training the de-reverberation model by using a reverberation audio spectrum of the reverberation audio as an input of the de-reverberation model and the time-frequency masking matrix corresponding to the de-reverberation as an output of the de-reverberation model; or
acquiring a clean audio and a reverberation audio thereof, generating a first target artificial reverberation audio based on the clean audio, and generating a second target artificial reverberation audio based on the reverberation audio; and training the de-reverberation model by using the reverberation audio as an input of the de-reverberation model and by using a time-frequency masking matrix corresponding to a ratio of the first target artificial reverberation audio to the second target artificial reverberation audio as an output of the de-reverberation model.

6. The audio reverberation method as described in claim 1, wherein the audio content feature comprises a music style; and the determining the content-adaptive masking matrix based on the audio content feature comprises:
determining, based on a music style detection probability at a current time point and suppression coefficients at different frequencies, a reverberation weighted weight related to a music style at the current time point.

7. The audio reverberation method as described in claim 1, wherein the audio content feature comprises drumbeat intensity; and the determining a content-adaptive masking matrix based on the audio content feature comprises:
determining, based on the drumbeat intensity at a current time point and a corresponding frequency, a reverberation weighted weight related to a drumbeat at the current time point by using a monotonically decreasing reverberation weight calculation function.

8. The audio reverberation method as described in claim 1, wherein the audio content feature comprises a reverberation degree, the reverberation degree being represented by a time-frequency masking matrix; and the determining a content-adaptive masking matrix based on the audio content feature comprises:
determining, based on a masking value in the time-frequency masking matrix corresponding to a current time-frequency point, a reverberation weighted weight related to a reverberation degree at the current time-frequency point by using a monotonically increasing reverberation weight calculation function.

9. The audio reverberation method as described in claim 1, wherein, when the input audio signal comprises a plurality of audio content features, the determining a content-adaptive masking matrix based on the audio content feature comprises:
determining a reverberation masking matrix corresponding to one of the audio content features respectively; and
combining the reverberation masking matrixes corresponding to the audio content features to obtain the content-adaptive masking matrix of the input audio signal.

10. An audio reverberation system, comprising:
a preprocessing module configured to preprocess an input audio signal to obtain a reverberation input signal;
a reverberation generation module configured to reverberation the reverberation input signal to generate an initial reverberation audio signal of a target scene;
an audio content analysis module configured to perform audio content analysis on the input audio signal to obtain an audio content feature of the input audio signal;
a content-adaptive masking module configured to determine a content-adaptive masking matrix based on the audio content feature;
a content-adaptive reverberation module configured to perform weighted mixing on the content-adaptive masking matrix and the initial reverberation audio signal to obtain a content-adaptive reverberation signal; and
a mixing module configured to perform weighted mixing on the content-adaptive reverberation signal and the reverberation input signal according to a preset ratio to obtain a final reverberation audio signal.
